(19) United States
(12) Patent Application Publication
(10) Pub. No.: US 2004/0095311 A1
(43) Pub. Date: May 20, 2004

(54) Body-centric virtual interactive apparatus and method

(75) Inventors: Mark Tarlton, Barrington, IL (US); Prakairut Tarlton, Barrington, IL (US); George Valliath, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/299,289

(22) Filed: Nov. 19, 2002

(51) Int. Cl. G09G 5/00; G09G 5/08

(52) U.S. Cl. 345/156; 345/157

(57) ABSTRACT

A body part position detector 12 (or detectors) provides information regarding the position of a predetermined body part to a virtual image tactile-entry information interface generator 12. The latter constructs a virtual image of the information interface that is proximal to the body part and that is appropriately scaled and oriented to match a viewer's point of view with respect to the body part. A display 13 then provides the image to the viewer. By providing the image of the information interface in close proximity to the body part, the viewer will experience an appropriate haptic sensation upon interacting with the virtual image.

### TECHNICAL FIELD

This invention relates generally to virtual reality displays and user initiated input.

### BACKGROUND

Virtual reality displays are known in the art, as are augmented reality displays and mixed reality displays (as used herein, “virtual reality” shall be generally understood to refer to any or all of these related concepts unless the context specifically indicates otherwise). In general, such displays provide visual information (as sometimes accompanied by corresponding audio information) to a user in such a way as to present a desired environment within which the user occupies and interacts. Such displays often provide for a display apparatus that is mounted relatively proximal to the user's eye. The information provided to the user may be wholly virtual or may be comprised of a mix of virtual and real-world visual information.

Such display technology presently serves relatively well to provide a user with a visually compelling and/or convincing virtual reality. Unfortunately, for at least some applications, the user's ability to interact convincingly with such virtual realities has not kept pace with the display technology. For example, virtual reality displays for so-called telepresence can be used to seemingly place a user at a face-to-face conference with other individuals who are, in fact, located at some distance from the user. While the user can see and hear a virtual representation of such individuals, and can interact with such virtual representations in a relatively convincing and intuitive manner to effect ordinary verbal discourse, existing virtual reality systems do not necessarily provide a similar level of tactile-entry information interface opportunities.

For example, it is known to essentially suspend a virtual view of an ordinary computer display within the user's field of vision. The user interacts with this information portal using, for example, an ordinary real-world mouse or other real-world cursor control device (including, for example, joysticks, trackballs, and other position/orientation sensors). While suitable for some situations, this scenario often leaves much to be desired. For example, some users may consider a display screen that hovers in space (and especially one that remains constantly in view substantially regardless of their direction of gaze) to be annoying, non-intuitive, and/or distracting.

Other existing approaches include the provision of a virtual input-interface mechanism that the user can interact with in virtual space. For example, a virtual “touch-sensitive” keypad can be displayed as though floating in space before the user. Through appropriate tracking mechanisms, the system can detect when the user moves an object (such as a virtual pointer or a real-world finger) to “touch” a particular key. One particular problem with such solutions, however, has been the lack of tactile feedback to the user when using such an approach. Without tactile feedback to simulate, for example, contact with the touch-sensitive surface, the process can become considerably less intuitive and/or accurate for at least some users. Some prior art suggestions have been made for ways to provide such tactile feedback when needed through the use of additional devices (such as special gloves) that can create the necessary haptic sensations upon command. Such approaches are not suitable for all applications, however, and also entail potentially considerable additional cost.

### BRIEF DESCRIPTION OF THE DRAWINGS

The above needs are at least partially met through provision of the body-centric virtual interactive apparatus and method described in the following detailed description, particularly when studied in conjunction with the drawings, wherein:

FIG. 1 comprises a block diagram as configured in accordance with an embodiment of the invention;

FIG. 2 comprises a front elevational view of a user wearing a two-eye head-mounted display device as configured in accordance with an embodiment of the invention;

FIG. 3 comprises a front elevational view of a user wearing a one-eye head-mounted display device as configured in accordance with an embodiment of the invention;

FIG. 4 comprises a flow diagram as configured in accordance with an embodiment of the invention;

FIG. 5 comprises a perspective view of a virtual keypad tactile-entry information interface as configured in accordance with an embodiment of the invention;

FIG. 6 comprises a perspective view of a virtual joystick tactile-entry information interface as configured in accordance with an embodiment of the invention;

FIG. 7 comprises a perspective view of a virtual drawing area tactile-entry information interface as configured in accordance with an embodiment of the invention;

FIG. 8 comprises a perspective view of a virtual switch tactile-entry information interface as configured in accordance with an embodiment of the invention;

FIG. 9 comprises a perspective view of a virtual wheel tactile-entry information interface as configured in accordance with an embodiment of the invention; and

FIG. 10 comprises a block diagram as configured in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a body-centric virtual interactive device can comprise at least one body part position detector, a virtual image tactile-entry information interface generator that couples to the position detector and that provides an output of a tactile-entry information interface in a proximal and substantially fixed relationship to a predetermined body part, and a display that provides that virtual image, such that a user will see the predetermined body part and the tactile-entry information interface in proximal and substantially fixed association therewith.

The body part position detector can comprise one or more of various kinds of marker-based and/or recognition/matching-based engines as appropriate to a given application. Depending upon the embodiment, the user's view of the predetermined body part itself can be either real, virtual, or a combination thereof The virtual information interface can be partially or wholly overlaid on the user's skin, apparel, or a combination thereof as befits the circumstances of a given setting.

In many of these embodiments, by providing the virtual image of the information interface in close (and preferably substantially conformal) proximity to the user, when the user interacts with the virtual image to, for example, select a particular key, the user will receive corresponding haptic feedback that results as the user makes tactile contact with the user's own skin or apparel. Such contact can be particularly helpful to provide a useful haptic frame of reference when portraying a virtual image of, for example, a drawing surface.

So configured, these embodiments generally provide for determining a present position of at least a predetermined portion of an individual's body, forming a virtual image of a tactile-entry information interface, and forming a display that includes the virtual image of the tactile-entry information interface in proximal and substantially fixed relationship with respect to the predetermined portion of the individual's body.

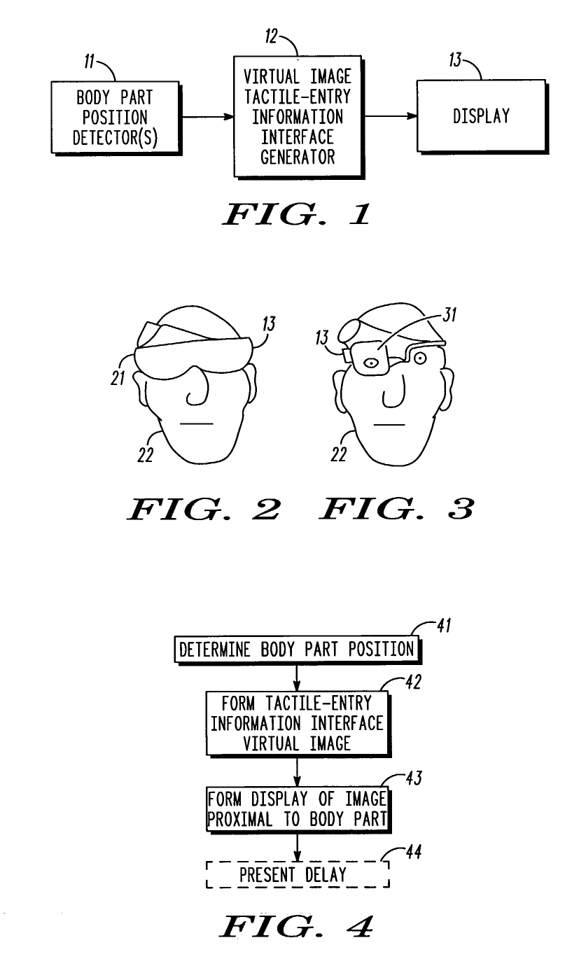

Referring now to the drawings, and in particular to FIG. 1, a body part position detector 11 serves to detect a present position of an individual's predetermined body part with respect to a predetermined viewer's point of view. The predetermined body part can be any body part, including but not limited to the torso or an appendage such as a finger, a hand, an arm, or a leg or any combination or part thereof Further, the predetermined body part may, or may not, be partially or fully clothed as appropriate to a given context. The viewer will usually at least include the individual whose body part the body part position detector detects. Depending upon the embodiment, however, the viewer can comprise a different individual and/or there can be multiple viewers who each have their own corresponding point of view of the body part.

There are many known ways to so detect the position of an individual's body part, and these embodiments are not especially limited in this regard. Instead, these embodiments can be implemented to one degree or another with any one or more such known or hereafter developed detection techniques, including but not limited to detection systems that use:

Visual position markers;

Magnetic position markers;

Radio frequency position markers;

Pattern-based position makers;

Shape recognition engines;

Gesture recognition engines; and

Pattern recognition engines.

Depending upon the context and application, it may be desirable to use more than one such detector (either more of the same type of detector or a mix of detectors to facilitate detector fusion) to, for example, permit increased accuracy of position determination, speed of position attainment, and/or increased monitoring range.

A virtual image tactile-entry information interface generator 12 receives the information from the body part position detector(s). This generator serves to generate the virtual image of a tactile-entry information interface as a function, at least in part, of

a desired substantially fixed predetermined spatial and orientation relationship between the body part and the virtual image of the information interface; and

the predetermined viewer's point of view.

So configured, the virtual image of the interface generator will appear to the viewer as being close to and essentially attached to the predetermined body part, as though the tactile-entry information interface were, in effect, being worn by the individual.

A display 13 receives the generated image information and provides the resultant imagery to a viewer. In a preferred embodiment, the display 13 will comprise a head-mounted display. With momentary reference to FIG. 2, the head-mounted display 13 can comprise a visual interface 21 for both eyes of a viewer. In the particular embodiment depicted, the eye interface 21 is substantially opaque. As a result, the viewer 22 sees only what the display 13 provides. With such a display 13, it would therefore be necessary to generate not only the virtual image of the tactile-entry information interface but also of the corresponding body part. With momentary reference to FIG. 3, the head-mounted display 13 could also comprise a visual interface 31 for only one eye of the viewer 22. In the particular embodiment depicted, the eye interface 31 is at least partially transparent. As a result, the viewer 22 will be able to see, at least to some extent, the real-world as well as the virtual-world images that the display 13 provides. So configured, it may only be necessary for the display 13 to portray the tactile-entry information interface. The viewer's sense of vision and perception will then integrate the real-world view of the body part with the virtual image of the information interface to yield the desired visual result.

The above display 13 examples are intended to be illustrative only, as other display mechanisms may of course be compatibly used as well. For example, helmetmounted displays and other headgear-mounted displays would serve in a similar fashion. It will also be appreciated that such displays, including both transparent and opaque displays intended for virtual reality imagery, are well known in the art. Therefore, additional details need not be provided here for the sake of brevity and the preservation of focus.

Referring now to FIG. 4, using the platform described above or any other suitable platform or system, the process determines 41 the present position of a predetermined body part such as a hand or wrist area (if desired, of course, more than one body part can be monitored in this way to support the use of multiple tactile-entry information interfaces that are located on various portions of the user's body). The process then forms 42 a corresponding tactile-entry information interface virtual image. For example, when the information interface comprises a keypad, the virtual image will comprise that keypad having a particular size, apparent spatial location, and orientation so as to appear both proximal to and affixed with respect to the given body part. Depending upon the embodiment, the virtual image may appear to be substantially conformal to the physical surface (typically either the skin and/or the clothing, other apparel, or outerwear of the individual) of the predetermined portion of the individual's body, or at least substantially coincident therewith.

Some benefits will be attained when the process positions the virtual image close to but not touching the body part. For many applications, however, it will be preferred to cause the virtual image to appear coincident with the body part surface. So configured, haptic feedback is intrinsically available to the user when the user interacts with the virtual image as the tactile-entry information interface that it conveys.

The process then forms 43 a display of the virtual image in combination with the body part. As already noted, the body part may be wholly real, partially real and partially virtual, or wholly virtual, depending in part upon the kind of display 13 in use as well as other factors (such as the intended level of virtual-world immersion that the operator desires to establish). When the body part is wholly real-world, then the display need only provide the virtual image in such a way as to permit the user's vision and vision perception to combine the two images into an apparent single image. The resultant image is then presented 44 on the display of choice to the viewer of choice.

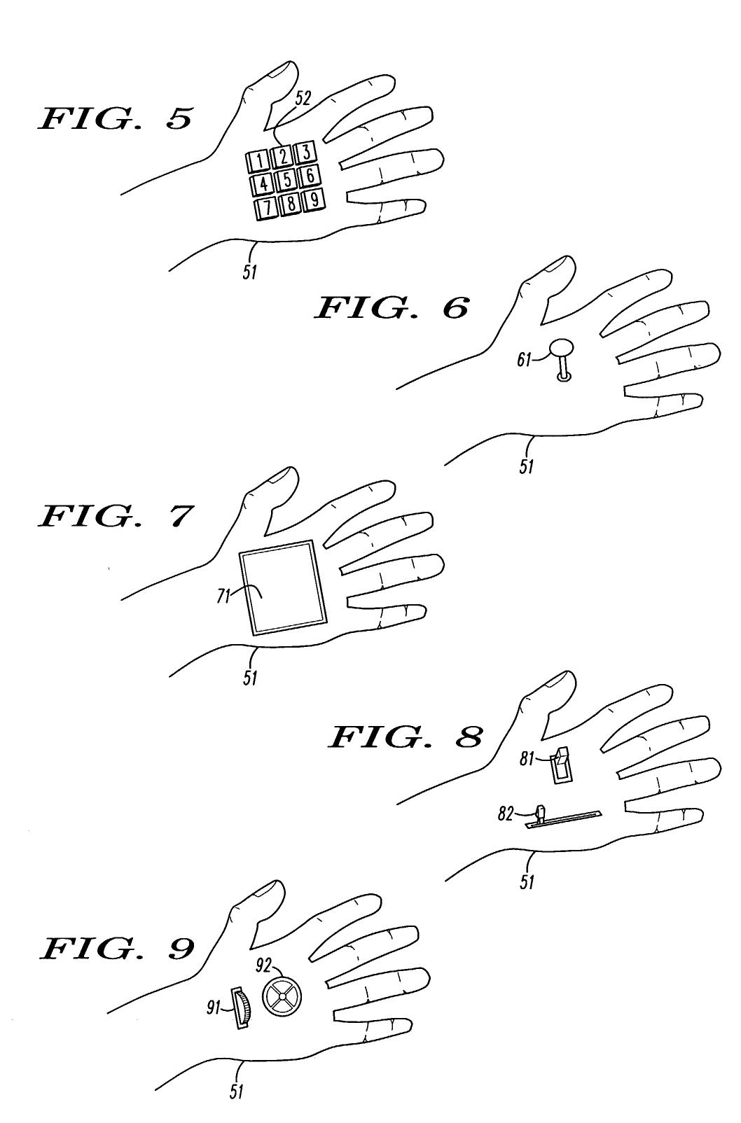

A virtually endless number of information interfaces can be successfully portrayed in this fashion. For example, with reference to FIG. 5, a multi-key keypad 52 can be portrayed (in this illustration, on the palm 51 of the hand of the viewer). The keypad 52, of course, does not exist in reality. It will only appear to the viewer via the display 13. As the viewer turns this hand, the keypad 52 will turn as well, again as though the keypad 52 were being worn by or was otherwise a part of the viewer. Similarly, as the viewer moves the hand closer to the eyes, the keypad 52 will grow in size to match the growing proportions of the hand itself Further, by disposing the virtual keypad 52 in close proximity to the body part, the viewer will receive an appropriate corresponding haptic sensation upon appearing to assert one of the keys with a finger of the opposing hand (not shown). For example, upon placing a finger on the key bearing the number “1” to thereby select and assert that key, the user will feel a genuine haptic sensation due to contact between that finger and the palm 51 of the hand. This haptic sensation, for many users, will likely add a considerable sense of reality to thereby enhance the virtual reality experience.

As already noted, other information interfaces are also possible. FIG. 6 portrays a joystick 61 mechanism. FIG. 7 depicts a writing area 71. The latter can be used, for example, to permit the entry of so-called grafiti-based handwriting recognition or other forms of handwriting recognition. Though achieved in a virtual context using appropriate mechanisms to track the handwriting, the palm 51 (in this example) provides a genuine real-world surface upon which the writing (with a stylus, for example) can occur. Again, the haptic sensation experience by the user when writing upon a body part in this fashion will tend to provide a considerably more compelling experience than when trying to accomplish the same actions in thin air.

FIG. 8 shows yet another information interface example. Here, a first switch 81 can be provided to effect any number of actions (such as, for example, controlling a light fixture or other device in the virtual or real-world environment) and a second sliding switch 82 can be provided to effect various kinds of proportional control (such as dimming a light in the virtual or real-world environment). And FIG. 9 illustrates yet two other interface examples, both based on a wheel interface. A first wheel interface 91 comprises a wheel that is rotatably mounted normal to the body part surface and that can be rotated to effect some corresponding control. A second wheel interface 92 comprises a wheel that is rotatably mounted essentially parallel to the body part surface and that can also be rotated to effect some corresponding control.

These examples are intended to be illustrative only and are not to be viewed as being an exhaustive listing of potential interfaces or applications. In fact, a wide variety of interface designs (alone or in combination) are readily compatible with the embodiments set forth herein.

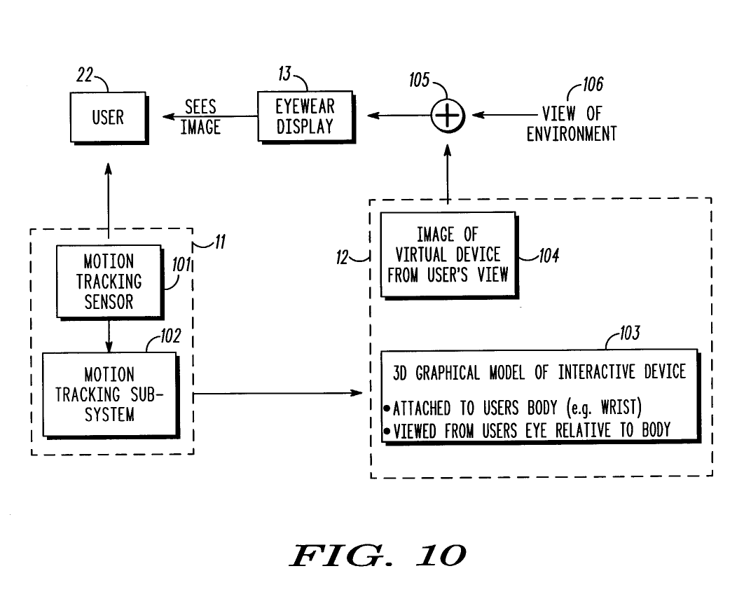

Referring now to FIG. 10, a more detailed example of a particular embodiment uses a motion tracking sensor 101 and a motion tracking subsystem 102 (both as well understood in the art) to comprise the body part position detector 11. Such a sensor 101 and corresponding tracking subsystem 102 are well suited and able to track and determine, on a substantially continuous basis, the position of a given body part such as the wrist area of a given arm. The virtual image generator 12 receives the resultant coordinate data. In this embodiment, the virtual image generator 12 comprises a programmable platform, such as a computer, that supports a 3 dimensional graphical model of the desired interactive device (in this example, a keypad). As noted before, the parameters that define the virtual image of the interactive device are processed so as to present the device as though essentially attached to the body part of interest and being otherwise sized and oriented relative to the body part so as to appear appropriate from the viewer's perspective. The resulting virtual image 104 is then combined 105 with the viewer's view of the environment 106 (this being accomplished in any of the ways noted earlier as appropriate to the given level of virtual immersion and the display mechanism itself). The user 22 then sees the image of the interface device as intended via the display mechanism (in this embodiment, an eyewear display 13).

In many instances, these teachings can be implemented with little or no additional cost, as many of the ordinary supporting components of a virtual reality experience are simply being somewhat re-purposed to achieve these new results. In addition, in many of these embodiments the provision of genuine haptic sensation that accords with virtual tactile interaction without the use of additional apparatus comprises a significant and valuable additional benefit.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, these teachings can be augmented through use of a touch and/or pressure sensor (that is, a sensor that can sense physical contact (and/or varying degrees of physical contact) between, for example, a user's finger and the user's interface-targeted skin area). Such augmentation may result in improved resolution and/or elimination of false triggering in an appropriate setting.

We claim:

1. A method comprising:
determining a present position of at least a predetermined portion of an individual's body;
forming a virtual image of a tactile-entry information interface;
forming a display that includes the virtual image of the tactile-entry information interface in proximal and substantially fixed relationship with respect to the predetermined portion of the individual's body.

2. The method of claim 1 wherein determining a present position of at least a predetermined portion of an individual's body includes determining a present position of at least an appendage of the individual's body.

3. The method of claim 1 wherein forming a virtual image of a tactile-entry information interface includes forming a virtual image that includes at least one of a keypad, a switch, a sliding device, a joystick, a drawing area, and a wheel.

4. The method of claim 1 wherein forming a display that includes the virtual image of the tactile information interface in proximal and substantially fixed relationship with respect to the predetermined portion of the individual's body includes forming a display wherein at least a portion of the tactile information interface is at least substantially conformal to a physical surface of the predetermined portion of the individual's body.

5. The method of claim 1 wherein forming a display that includes the virtual image of the tactile information interface in proximal and substantially fixed relationship with respect to the predetermined portion of the individual's body includes forming a display wherein at least a portion of the tactile information interface is substantially coincident with a physical surface of the predetermined portion of the individual's body.

6. The method of claim 5 wherein forming a display wherein at least a portion of the tactile information interface is substantially coincident with a physical surface of the predetermined portion of the individual's body includes forming a display wherein at least a portion of the tactile information interface is substantially coincident with an exposed skin surface of the predetermined portion of the individual's body.

7. The method of claim 1 and further comprising presenting the display to the individual.

8. The method of claim 7 wherein presenting the display to the individual includes presenting the display to the individual using a head-mounted display.

9. The method of claim 7 wherein presenting the display to the individual includes detecting an input from the individual indicating that the display is to be presented.

10. The method of claim 1 and further comprising presenting the display to at least one person other than the individual.

11. An apparatus comprising:
at least one body part position detector;
a virtual image tactile-entry information interface generator having an input operably coupled to the position detector and an output providing a virtual image of a tactile-entry information interface in a proximal and substantially fixed relationship to a predetermined body part;
a display operably coupled to the virtual image tactile-entry information interface wherein the display provides an image of the tactile-entry information interface in a proximal and substantially fixed relationship to the predetermined body part, such that a viewer will see the predetermined body part and the tactile-entry information interface in proximal and fixed association therewith.

12. The apparatus of claim 11 wherein at least one body part position detector includes at least one of a visual position marker, a magnetic position marker, a radio frequency position marker, a pattern-based position marker, a gesture recognition engine, a shape recognition engine, and a pattern matching engine.

13. The apparatus of claim 11 wherein the virtual image tactile-entry information interface generator includes generator means for generating the virtual image of the tactile-entry information interface.

14. The apparatus of claim 13 wherein the generator means further combines the virtual image of the tactile-entry information interface with a digital representation of the predetermined body part.

15. The apparatus of claim 11 wherein the display comprises a head-mounted display.

16. The apparatus of claim 15 wherein the head-mounted display includes at least one eye interface.

17. The apparatus of claim 16 wherein the head-mounted display includes at least two eye interfaces.

18. The apparatus of claim 16 wherein the at least one eye interface is at least partially transparent.

19. The apparatus of claim 16 wherein the at least one eye interface is substantially opaque.

20. The apparatus of claim 11 wherein the virtual image of a tactile-entry information interface includes at least one of a keypad, a switch, a sliding device, a joystick, a drawing area, and a wheel.

21. The apparatus of claim 11 wherein at least part of the image of the tactile-entry information interface appears on the display to be disposed substantially on the predetermined body part.

22. An apparatus for forming a virtual image of a tactile-entry information interface having a substantially fixed predetermined spatial and orientation relationship with respect to a portion of an individual's body part, comprising:
position detector means for detecting a present position of the individual's body part with respect to a predetermined viewer's point of view;
image generation means responsive to the position detector means for providing a virtual image of a tactile-entry information interface as a function, at least in part, of:
the substantially fixed predetermined spatial and orientation relationship; and
the predetermined viewer's point of view;
display means responsive to the image generation means for providing a display to the predetermined viewer, which display includes the individual's body part and the virtual image of the tactile-entry information interface from the predetermined viewer's point of view.

23. The apparatus of claim 22 and further comprising interaction detection means for detecting spatial interaction between at least one monitored body part of the individual and an apparent location of the virtual image of the tactile-entry information interface.
